(19) United States
(12) Patent Application Publication
(10) Pub. No.: US 2025/0298046 A1
(43) Pub. Date: Sep. 25, 2025

(54) ADAPTABLE PIERCEABLE SEALING FOR PIPETTE TIPS

(71) Applicant: Andrew Alliance S. A., Canton of Geneva (CH)

(72) Inventor: Giorgio Horak, Genève (CH)

(21) Appl. No.: 19/086,366

(22) Filed: Mar. 21, 2025

Related U.S. Application Data
(60) Provisional application No. 63/568,575, filed on Mar. 22, 2024.

(51) Int. Cl. G01N 35/00; G01N 35/10

(52) U.S. Cl. CPC G01N 35/0099; G01N 35/1079; G01N 2035/103

(57) ABSTRACT

A robotic sample handling system includes a labware rack holding a sample container having an opening and containing a sample, a robotic sampling system including a pipette tip, a pierceable sealing device, and a robotic gripper configured to manipulate the labware rack and the pierceable sealing device. The pierceable sealing device includes a base plate an opening and is configured to be placed over the labware rack such that the opening of the sample container aligns with the opening of the base plate. A sealing membrane extends over and seals the opening of the base plate. The sealing membrane includes a pre-cut opening configured to allow a pipette tip to extend through the pre-cut opening to access the sample container through the opening of the sample container. The pre-cut opening is configured to automatically reseal during removal of the pipette tip.

### RELATED APPLICATION

This application claims priority to U.S. provisional patent application No. 63/568,575 filed Apr. 2, 2024 and titled “Adaptable Pierceable Sealing for Pipette Tips,” the entirety of which is incorporated by reference herein.

### FIELD OF THE INVENTION

The disclosed technology generally relates to a device and method for maintaining sealing and preventing loss of samples from containers. More particularly, the technology relates to a device and method for adaptable pierceable sealing which re-seals after an interaction with a pipette tip is completed.

### BACKGROUND

The problem of labware sealing to block the evaporation of reagents or samples is a common challenge in various laboratory and scientific applications. There is a need to prevent the loss of, for example, volatile or moisture-sensitive substances within laboratory containers (such as microtubes, test tubes, vials, beakers, flasks, or microplates) due to the natural process of evaporation. Evaporation can lead to changes in concentration, degradation of reagents, or contamination of the lab environment, which can significantly impact the accuracy and reliability of experimental results.

Several methods and solutions are known to address the problem of labware sealing to prevent reagent evaporation. The most common solution is the usage of covers, lids or caps on containers that can provide a physical barrier that limits the exposure of reagents into the atmosphere. Nevertheless, the automation or application of this solution is often cumbersome.

Therefore, an adaptable pierceable sealing device and method which addresses the present problems in a manner which can be easily automated would be well received in the art.

### SUMMARY

In one aspect, a device for pierceable sealing of a container includes a base plate including a thickness and extending between a first end and a second end, the base plate including at least one opening extending through the thickness. The base plate is configured to be placed over a labware rack configured to hold at least one sample container such that an opening of the at least one sample container aligns with the at least one opening of the base plate. The device for pierceable sealing of the container further includes at least one sealing membrane extending over and sealing the at least one opening, the at least one sealing membrane including a pre-cut opening configured to allow a pipette tip to extend through the pre-cut opening of the at least one sealing membrane to access the at least one sample container through the opening of the at least one sample container, where the pre-cut opening is configured to automatically reseal during removal of the pipette tip.

In another aspect, a method of pierceable sealing of a container includes providing a device comprising: a base plate including a thickness and extending between a first end and a second end, the base plate including at least one opening extending through the thickness; and at least one sealing membrane extending over and sealing the at least one opening, the at least one sealing membrane including a pre-cut opening. The method further includes providing a labware rack holding at least one sample container containing a sample, and providing a pipette tip. The method further includes placing the base plate over the labware rack holding the at least one sample container such that the opening of the at least one sample container aligns with the opening of the base plate and such that the at least one sealing membrane extends over and seals the at least one opening of the at least one sample container; extending the pipette tip through the pre-cut opening of the at least one sealing membrane; accessing the sample in the at least one container with the pipette tip through the pre-cut opening of the at least one sealing membrane and the opening of the at least one sample container; and removing the pipette tip through the pre-cut opening of the at least one sealing membrane such that the pre-cut opening automatically reseals during the removing.

In another aspect a robotic sample handling system includes a labware rack holding at least one sample container having an opening and containing a sample, a robotic sampling system including a pipette tip, and a pierceable sealing device. The pierceable sealing device includes a base plate including a thickness and extending between a first end and a second end, the base plate including at least one opening extending through the thickness. The base plate is configured to be placed over the labware rack such that the opening of the at least one sample container aligns with the at least one opening of the base plate. The pierceable sealing device further includes at least one sealing membrane extending over and sealing the at least one opening, the at least one sealing membrane including a pre-cut opening configured to allow a pipette tip to extend through the pre-cut opening of the at least one sealing membrane to access the at least one sample container through the opening of the at least one sample container, where the pre-cut opening is configured to automatically reseal during removal of the pipette tip. The robotic sample handling system further includes a robotic gripper configured to manipulate the labware rack and the pierceable sealing device.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 depicts an exploded perspective view of a labware rack, sample containers, a rack holder device, and three devices for pierceable sealing of the sample containers, in accordance with one embodiment.

FIG. 2 depicts an assembled perspective view of the labware rack, the sample containers, the rack holder device, and the three devices for pierceable sealing of the sample containers of FIG. 1, in accordance with one embodiment.

FIG. 3 depicts a perspective view of the labware rack, the sample containers, the rack holder device, and the three devices for pierceable sealing of the sample containers of FIGS. 1 and 2 interacted with a robotic gripper, in accordance with one embodiment.

FIG. 4A depicts a perspective top view of one of the devices for pierceable sealing of sample containers FIGS. 1-3, in accordance with one embodiment.

FIG. 4B depicts a perspective bottom view of the device for pierceable sealing of sample containers of FIG. 4A, in accordance with one embodiment.

FIG. 5 depicts a side cross sectional view of the device for pierceable sealing of sample containers FIG. 4, taken at arrows 5-5, in accordance with one embodiment.

FIG. 6 depicts a perspective view of another device for pierceable sealing of sample containers, in accordance with one embodiment.

FIG. 7 depicts a perspective view of another device for pierceable sealing of sample containers, in accordance with one embodiment.

FIG. 8 depicts a perspective view of an array device for pierceable sealing of sample containers, in accordance with one embodiment.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

In brief overview, embodiments and examples disclosed herein are directed to a device and method for adaptable pierceable sealing which re-seals after an interaction with a pipette tip is completed. Embodiments described herein address the challenges of labware sealing, particularly in lab automation scenarios. Thus, embodiments herein prevent the loss of volatile or moisture sensitive substances in laboratory sample containers (such as microtubes, test tubes, vials, beakers, flasks, or microplates), thereby improving experimental precision and preventing the extraction of possibly harmful fumes into the experimental environment. Further, embodiments herein maintain reagents and samples in the dark during experiments, protecting reagents and samples from exposure to harmful light. Still further, embodiments described herein provide for re-sealing in automated solutions and reduces the need for user interaction and intervention to open and close consumables.

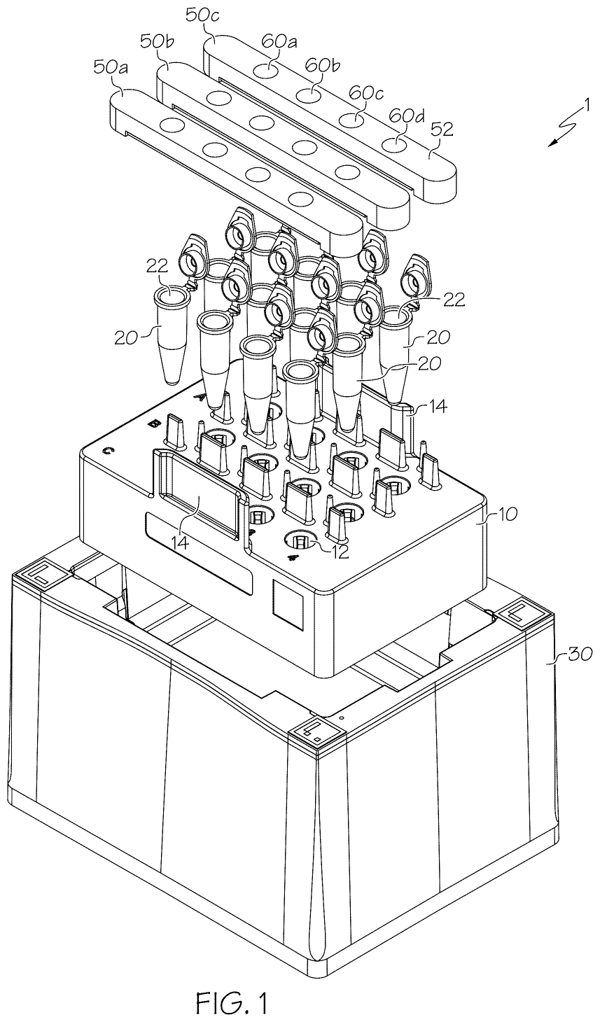

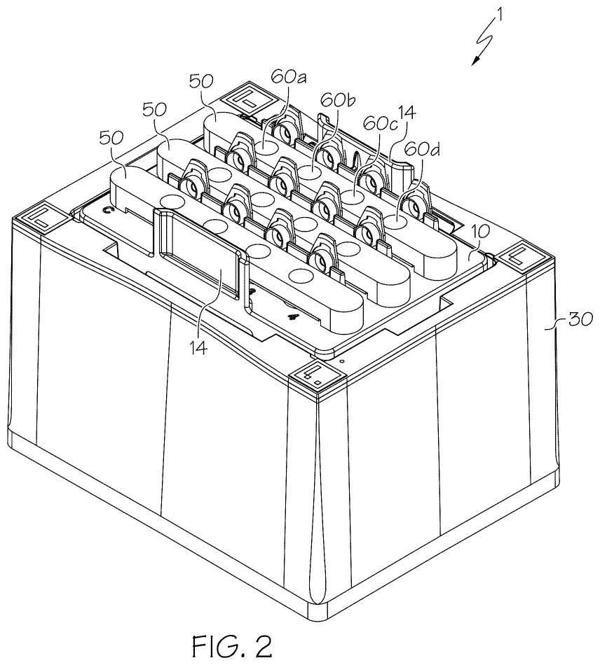

FIG. 1 depicts an exploded perspective view of a sample handling system 1 including a labware rack 10, sample containers 20, a rack holder device 30, and three devices 50a, 50b, 50c (generally 50) for pierceable sealing of the sample containers 20, in accordance with one embodiment. Reference is also made to FIG. 2, which depicts an assembled perspective view of the labware rack 10, the sample containers 20, the rack holder device 30, and the three devices for pierceable sealing of the microtubes 50 of FIG. 1, in accordance with one embodiment.

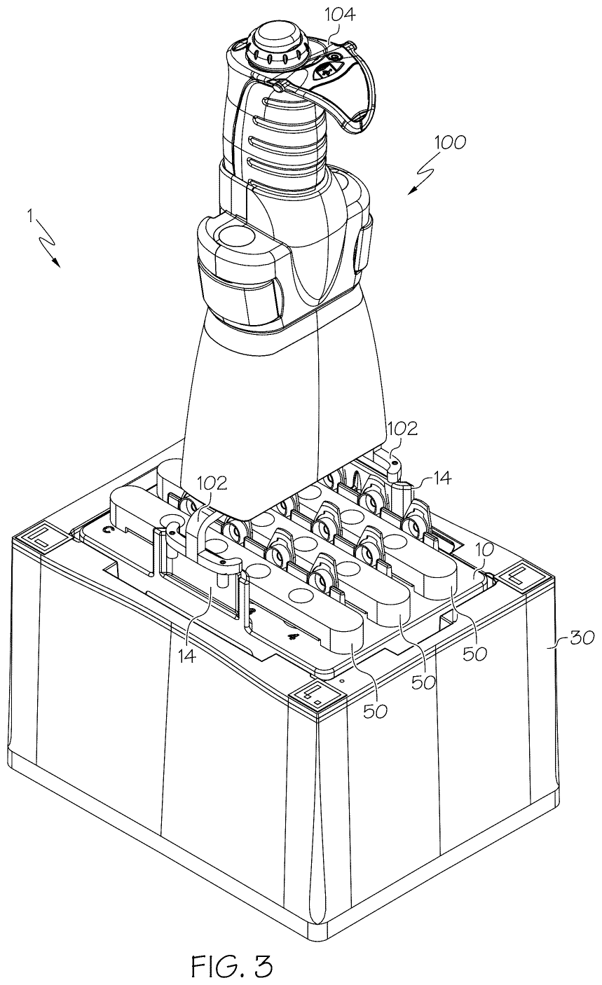

The rack holder device 30 may be compatible with a variety of labware racks, such as the labware rack 10. The rack holder device 30 may be configured to enable fully automated solid phase extraction workflows, for example, by allowing automated consumable movements to and from the base by a robotic system (e.g. the robotic system 100 shown in FIG. 3). It should be understood that the rack holder device 30 shown in FIGS. 1-3 is exemplary, and embodiments described herein may be used with any consumable holding structure.

The labware rack 10 is dimensionally configured to fit within any opening of the rack holder device 30, as shown. The labware rack 10 shown is configured to hold twelve separate sample containers, but various embodiments of labware racks 10 contemplated may hold any number of sample containers. The labware rack 10 includes a plurality of openings 12 each configured to receive and hold one of the sample containers 20. The labware rack 10 includes a depth corresponding to the depth of the sample containers 20 held therein. The labware rack 10 further includes a pair of robotic gripper interfaces 14 which are configured to be interacted with by a robotic gripper to automate manipulation of the sample handling, as described herein below.

The sample containers 20 are shown as microtubes in the embodiment depicted. However, the sample containers 20 may be any container configured to hold a sample, such as a test tube, vial, beaker, flask or microplate. Whatever the embodiment, the sample containers 20 may each include a container opening 22 located at a top of the sample container 20 and configured to provide access to the sample or material within the sample container 20. As shown, the sample containers 20 may each further include a removable cap 24. In other embodiments, no cap may be provided, but instead the containers 20 may be sealed by a pierceable or puncturable membrane covering the sample container 20. The sample container 20 shown thereby represents any sample container having an opening through which a sample may be accessible via a needle, pipette or nozzle.

FIG. 3 depicts a perspective view of the labware rack 10, the sample containers 20, the rack holder device 30, and the three devices 50 for pierceable sealing of the sample containers of FIGS. 1 and 2 interacted with a robotic system 100, in accordance with one embodiment. The robotic system 100 includes a gripper 102 that extends from a main body 104. In some embodiments, the gripper 102 may be an attachment to the main body 104. The main body 104 may be attachable to a robotic movement system (not shown), such as for example a gantry system. The robotic system 100 may be controllable within the robotic movement system and may be configured to move around the perform mechanical functions within the sample handling system 1 such as dispensing samples, moving the various components of the system into position, and the like. In the embodiment shown, the gripper 102 may be particularly configured to

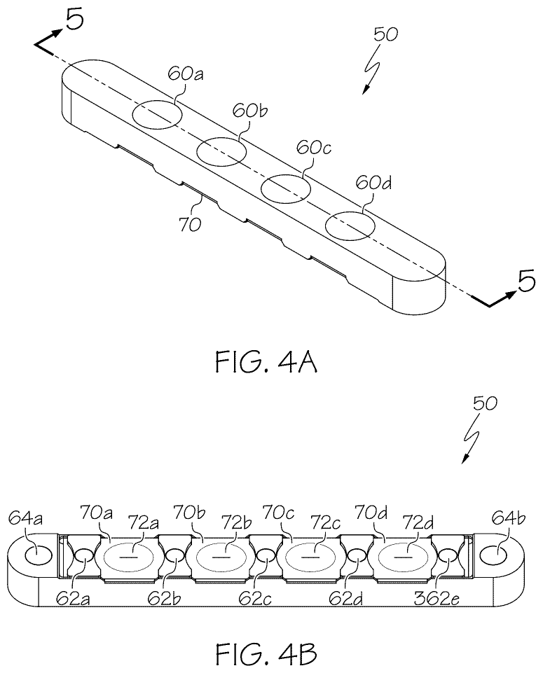

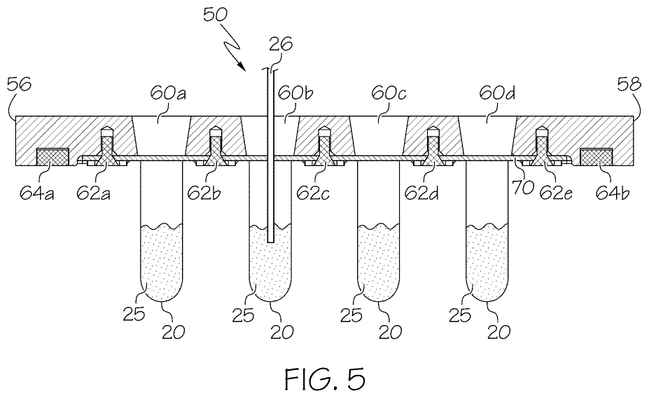

FIG. 4A depicts a perspective top view of the device for pierceable sealing 50 of FIGS. 1-3, while FIG. 4B depicts a perspective bottom view of the device for pierceable sealing of sample containers of FIG. 4A, in accordance with one embodiment. Reference is also made to FIG. 5, which depicts a side cross sectional view of the device for pierceable sealing of FIGS. 4A and 4B located above sample containers 20 containing samples 25 in accordance with one embodiment.

The device 50 includes a base plate 52 having a thickness 54. The device 50 extends between a first end 56 and a second end 58. The base plate 52 shown is configured to cover a single row of the sample containers 20 within the labware rack 10 shown in FIGS. 1-3. The base plate 52 includes a plurality of openings 60a, 60b, 60c, 60d (generally 60) extending through the thickness 54. When the base plate 50 is placed over the labware rack 10, the openings 22 of the sample containers 20 are configured to align with the openings 60a, 60b, 60c, 60d of the base plate 52.

The device 50 further includes sealing membranes 70a, 70b, 70c, 70d (generally 70) extending over and sealing each of the openings 60 of the base plate. The sealing membranes 70 each include a pre-cut opening 72a, 72b, 72c, 72d (generally 72). Each sealing membrane 70 is configured to allow a pipette tip 26 to extend through the pre-cut opening 72 of the sealing membrane 70 to access the corresponding aligned sample container 20 through the opening 60 thereof. The pre-cut openings 72 are each configured to automatically reseal during and/or after removal of the pipette tip 26. As shown in FIG. 4B, the pre-cut openings 72 may each form a single narrow slit cut into the sealing membrane 70.

The sealing membrane 70 may be four separate sealing membranes, or maybe a single long strip of sealing membrane 70 extending across an entire length of the device 50. For example, the base plate 52 of the device 50 may include an array of four openings 60a, 60b, 60c, 60d, and the sealing membrane 70 may be a plurality of sealing membranes 70a, 70b, 70c, 70d each corresponding to one of the array of openings 60a, 60b, 60c, 60d in the base plate 52. In other embodiments, the sealing membrane may be a single strip of material extending across an entirety of the device 50.

As shown in FIG. 5, the sealing membranes 70 may be located at a bottom of the device 50 under each of the array of openings 60a, 60b, 60c, 60d. The sealing membranes 70 may be configured to abut the top of the sample containers 20 to provide sealing therewith. A pressure or force may be provided between the sealing membranes 70 and the tops of the sample containers 20 in order to provide a degree of sealing. Any degree of sealing is contemplated, including air tight sealing, around a circumference of the sample container openings.

The sealing membrane 70 may be made of, for example, a silicon membrane material. In other embodiments, the sealing membrane may be made of a polypropylene material or any other appropriate material. Whatever the material, the material may be of sufficient elasticity to return to its original position and re-seal after the pipette tip 26 (or a needle or other sampling device) has been inserted into the container through the pre-cut opening 72. The elasticity of the sealing membrane 70 may be optimized to allow for an exhaust of air from the sample container 20 when the pipette tip 26 extends through the pre-cut opening 72. The elasticity of the sealing membrane 70 may also be optimized or otherwise configured to clear an outer surface of the pipette tip 26 from liquid carryover with the at least one sealing membrane 70 during the removal of the pipette tip 26. In some embodiments, the sealing membrane 70 may be at least partially or fully opaque, for example, to prevent damaging light from entering into the sample containers 20 through the openings 22, 60.

As shown in FIGS. 4B and 5, the base plate 52 may include a first magnet 64a located proximate the first end 56, and a second magnet located proximate the second end 58. The first and second magnets 64a, 64b may be configured to magnetically attach the base plate 52 and/or the device 50 to the labware rack 10. While a magnetic attachment is contemplated for ease of attachment via the robotic system 100, other attachment mechanisms are also contemplated, such as a clasp, clamp, snap-fit attachment mechanism, or the like. Thus, the base plate 52 is configured to be attachable to the labware rack 10 automatically with the robotic gripper 100 without human intervention. When attached, base plate 52 of the device 50 may include enough attachment force to create a sufficient seal between the sealing membrane 70 and the openings 22 of the sample containers 20.

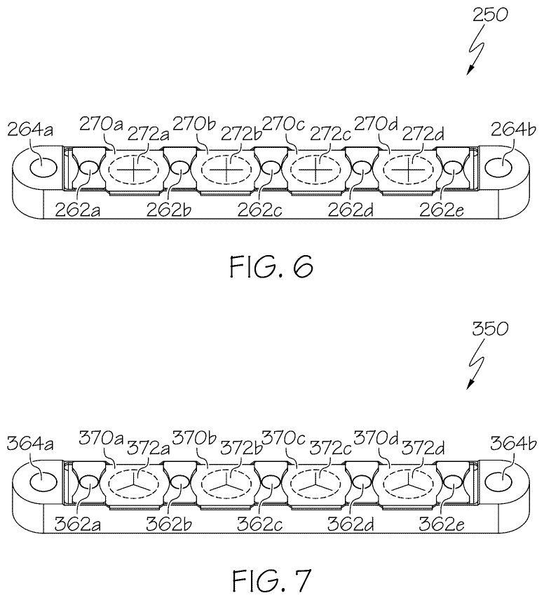

FIG. 6 depicts a perspective view of another device for pierceable sealing 250, in accordance with one embodiment. The device for pierceable sealing 250 is the same the device for pierceable sealing 50 described herein above, with the difference being that the device for pierceable sealing 250 includes a sealing membrane 270 having pre-cut openings 272a, 272b, 270c, 272d in the shape of a cross shaped slit, rather than a single lengthwise slit.

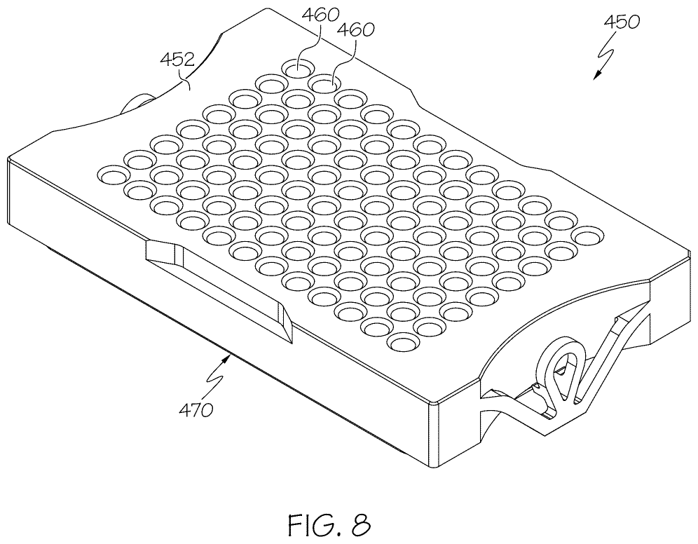

FIG. 7 depicts a perspective view of another device for pierceable sealing 350, in accordance with one embodiment. The device for pierceable sealing 350 is the same the devices for pierceable sealing 50, 250 described herein above, with the difference being that the device for pierceable sealing 350 includes a sealing membrane 370 having pre-cut openings 372a, 372b, 372c, 372d in the shape of a three-way intersection slit (i.e. a Y intersection slit) rather than a single lengthwise slit or a cross shaped slit. Thus, various pre-cut opening shapes and structures are contemplated, which, in conjunction with the elasticity of the material of the sealing membrane 370, may be configured to re-seal the sealing membrane 370 in the manner described herein.

FIG. 8 depicts a perspective view of an array device 450 for pierceable sealing, in accordance with one embodiment. The array device 450 may deploy one or more sealing membrane(s) 470, as described hereinabove. Rather than a single lengthwise device covering a single row of sample containers within a labware rack 10, the array device 450 includes a base plate 452 having a sufficient width and plurality of openings 460 such that the array device 450 is configured to cover an array of sample containers across a plurality of rows of a labware rack. Like the previous devices, the base plate may include one or more robotic gripper interface configured to become removably attachable to a robotic gripper. Still further, in the array device 450, any sealing membrane arrangement may be deployed, including using individual sealing membranes for each opening 460, or using a plurality of row or column sized strips of sealing membrane extending across an entire row or column. Still further, a single membrane sheet may be deployed extending over the entire array of the array device 450. Whatever the embodiment, the sealing membranes may extend across the bottom of each opening 460 and provide a sealing surface over a vial or sample container as described herein above.

Thus, principles described herein contemplate any number of openings and pre-cut openings with any structural base plate 452. In the embodiment depicted, a plurality magnets (e.g., four magnets, one on each corner) may be deployed to sufficiently attach the array device 450 to the labware rack 10.

Methods of sealing are also contemplated which may include providing a sealing device, such as one of the devices 50, 250, 350, 450 described above, as well as providing a labware rack, such as the labware rack 10, holding at least one sample container, such as the sample containers 20. Methods may include providing a pipette tip, such as the pipette tip 26.

Methods may include placing a base plate of a sealing device over the labware rack holding the at least one sample container such that the opening of the at least one sample container aligns with the opening of the base plate and such that the at least one sealing membrane extends over and seals the at least one opening of the at least one sample container. Methods include extending the pipette tip through the pre-cut opening of the at least one sealing membrane. Methods include accessing the sample in the at least one sample container with the pipette tip through the pre-cut opening of the at least one sealing membrane and the opening of the at least one sample container. Methods further include removing the pipette tip through the pre-cut opening of the at least one sealing membrane such that the pre-cut opening automatically reseals during the removing.

Methods may also include, for example, magnetically attaching the base plate to the labware rack, and attaching the base plate to the labware rack with a robotic gripper without human intervention.

Methods may further include clearing an outer surface of the pipette tip from liquid carryover with the at least one sealing membrane during the removal of the pipette tip. Still further, methods may include optimizing the elasticity of the at least one sealing member to allow for an exhaust of air from the at least one sample container when pipette tip extends through the pre-cut opening. Moreover, methods may include preventing environmental light from entering the at least one sample container through the at least one sealing member.

While various examples have been shown and described, the description is intended to be exemplary, rather than limiting and it should be understood by those of ordinary skill in the art that various changes in form and detail may be made therein without departing from the scope of the invention as recited in the accompanying claims.

What is claimed is:

1. A device for pierceable sealing of a sample container, comprising:
a base plate including a thickness and extending between a first end and a second end, the base plate including at least one opening extending through the thickness, wherein the base plate is configured to be placed over a labware rack configured to hold at least one sample container such that an opening of the at least one sample container aligns with the at least one opening of the base plate; and
at least one sealing membrane extending over and sealing the at least one opening, the at least one sealing membrane including a pre-cut opening configured to allow a pipette tip to extend through the pre-cut opening of the at least one sealing membrane to access the at least one sample container through the opening of the at least one sample container, wherein the pre-cut opening is configured to automatically reseal during removal of the pipette tip.

2. The device of claim 1, wherein the base plate includes at least one magnet configured to magnetically attach the base plate to the labware rack.

3. The device of claim 1, wherein the at least one opening of the base plate includes an array of openings, and wherein the at least one sealing membrane includes a plurality of sealing membranes each corresponding to one of the array of openings of the base plate.

4. The device of claim 3, wherein the base plate includes a first magnet located at the first end and a second magnet located at the second end, wherein the first and second magnets are configured to magnetically attach the base plate to the labware rack.

5. The device of claim 1, wherein at least one sealing membrane is made of a silicon membrane material.

6. The device of claim 1, wherein at least one sealing membrane is made of a polypropylene material.

7. The device of claim 1, wherein the pre-cut opening includes a narrow slit.

8. The device of claim 7, wherein the narrow slit is a cross shaped slit.

9. The device of claim 1, wherein the at least one sealing membrane is opaque.

10. The device of claim 1, wherein the elasticity of the at least one sealing membrane is configured to clear an outer surface of the pipette tip from liquid carryover with the at least one sealing membrane during the removal of the pipette tip.

11. The device of claim 1, wherein the elasticity of the at least one sealing membrane is optimized to allow for an exhaust of air from the sample container when pipette tip extends through the pre-cut opening.

12. The device of claim 1, wherein the base plate is configured to be attachable to the labware rack automatically with a robotic gripper without human intervention.

13. A method of pierceable sealing of a sample container, comprising:
providing a device comprising:
a base plate including a thickness and extending between a first end and a second end, the base plate including at least one opening extending through the thickness; and
at least one sealing membrane extending over and sealing the at least one opening, the at least one sealing membrane including a pre-cut opening;
providing a labware rack holding at least one sample container containing a sample;
providing a pipette tip;
placing the base plate over the labware rack holding the at least one sample container such that the opening of the at least one sample container aligns with the opening of the base plate and such that the at least one sealing membrane extends over and seals the at least one opening of the at least one sample container;
extending the pipette tip through the pre-cut opening of the at least one sealing membrane;
accessing the sample in the at least one sample container with the pipette tip through the pre-cut opening of the at least one sealing membrane and the opening of the at least one sample container; and
removing the pipette tip through the pre-cut opening of the at least one sealing membrane such that the pre-cut opening automatically reseals during the removing.

14. The method of claim 13, further comprising magnetically attaching the base plate to the labware rack.

15. The method of claim 14, further comprising attaching the base plate to the labware rack with a robotic gripper without human intervention.

16. The method of claim 13, further comprising clearing an outer surface of the pipette tip from liquid carryover with the at least one sealing membrane during the removal of the pipette tip.

17. The method of claim 13, further comprising optimizing the elasticity of the at least one sealing member to allow for an exhaust of air from the at least one sample container when pipette tip extends through the pre-cut opening.

18. The method of claim 13, further comprising preventing environmental light from entering the at least one sample container through the at least one sealing member.

19. A robotic sample handling system comprising:
a labware rack holding at least one sample container containing a sample, the at least one sample container including an opening;
a robotic sampling system including a pipette tip;
a pierceable sealing device, comprising:
a base plate including a thickness and extending between a first end and a second end, the base plate including at least one opening extending through the thickness, wherein the base plate is configured to be placed over the labware rack such that the opening of the at least one sample container aligns with the at least one opening of the base plate; and
at least one sealing membrane extending over and sealing the at least one opening, the at least one sealing membrane including a pre-cut opening configured to allow a pipette tip to extend through the pre-cut opening of the at least one sealing membrane to access the at least one sample container through the opening of the at least one sample container, wherein the pre-cut opening is configured to automatically reseal during removal of the pipette tip; and
a robotic gripper configured to manipulate the labware rack and the pierceable sealing device.
